(19) United States
(12) Patent Application Publication
(10) Pub. No.: US 2010/0253457 A1
(43) Pub. Date: Oct. 7, 2010

(54) METHOD FOR CONTROLLING MOVABLE INDUCTOR BY USING MAGNETISM AND DEVICE THEREOF

(75) Inventors: Yu-Che Huang, Ylian County (TW); Ben-Hwa Jang, Taipei City (TW); Weileun Fang, Hsinchu City (TW)

Correspondence Address: BENESCH, FRIEDLANDER, COPLAN & ARONOFF LLP;ATTN: IP DEPARTMENT DOCKET CLERK, 200 PUBLIC SQUARE, SUITE 2300, CLEVELAND, OH, 44114-2378, US

(73) Assignee: National Tsing Hua University, Hsinchu City (TW)

(21) Appl. No.: 12/489,780

(22) Filed: Jun. 23, 2009

(30) Foreign Application Priority Data
Apr. 2, 2009 (TW) 098111084

(51) Int. Cl. H01F 21/04; H01F 41/00

(52) U.S. Cl. 336/115; 29/602.1

(57) ABSTRACT

A movable inductor using magnetism is provided. The movable inductor includes a substrate; a first structure layer disposed on the substrate, and having two protruding portions respectively disposed at two sides thereof; at least two fixing elements disposed on the substrate, and connected with the protruding portions; and a thermal bonding layer at least disposed on the fixing elements.

### FIELD OF THE INVENTION

The present invention relates to a method for controlling a movable inductor and the device thereof, and more particularly to a method for controlling a movable inductor by using magnetism and the device thereof.

### BACKGROUND OF THE INVENTION

The on-chip inductor is an important element in the radio frequency integrated circuit (RFIC). However in the tradition, the parasitic capacitor and loss will arise between inductors which are parallel to the silicon substrate. Besides, when the inductor is powered on, a magnetic field is generated whose direction is perpendicular to the silicon substrate. This reduces the effect of storing energy and causes a low quality factor (Q) as well as a low self-resonant frequency (fᵣₑₛ), which makes the on-chip inductor unfavorable to the industrial application.

The sensitivity of an ideal inductor will not change due to the magnitude of the current passing through the coil. However in practice, the resistor inside the inductor will consume the energy so that the quality thereof is affected. The higher the Q value is, the better the performance of the inductor is. Moreover, fᵣₑₛ represents the upper limit of the operating frequency for an inductor. The performance of the inductor is normal only when the operating frequency is lower than fᵣₑₛ. The influence of the parasitic capacitor on the inductor will be gradually increased when the operating frequency gradually approaches fᵣₑₛ.

For improving the above-mentioned drawbacks, the inductor is separated from the substrate to enhance the Q value and fᵣₑₛ, which has been achieved in the process of the micro-electro-mechanical system (MEMS). In IEEE MTT-S Digest, Phoenix, May, 2001, pp. 329-332, G W. Dahlmann et al. propose a method of using the surface tension resulting from the welding material which is heated and melted to elevate the structure. The elevated structure can be fixed when the welding material is solidified, thereby achieving the effect of self-assembling. However, such method cannot precisely control the elevating angle, and the Q value of the inductor as well as the corresponding fᵣₑₛ also cannot be adjusted according to actual needs.

In order to overcome the drawbacks in the prior art, a method for controlling the movable inductor by using magnetism and the device thereof are provided. The particular design in the present invention not only solves the problems described above, but also is easy to be implemented. Thus, the present invention has the utility for the industry.

### SUMMARY OF THE INVENTION

In accordance with one aspect of the present invention, a movable inductor using magnetism is provided. The movable inductor includes a substrate; a first structure layer disposed on the substrate, and having two protruding portions respectively disposed at two sides thereof; at least two fixing elements disposed on the substrate, and connected with the protruding portions; and a thermal bonding layer at least disposed on the fixing elements.

Preferably, the movable inductor further includes a metal layer disposed on the substrate and coplanar with the fixing elements, wherein a part of the thermal bonding layer is disposed on the metal layer.

Preferably, the metal layer includes one selected from a group consisting of Au, Ag, Cu, Ni, Au alloy, Ag alloy, Cu alloy and Ni alloy.

Preferably, the movable inductor further includes a metal layer disposed beneath the substrate.

Preferably, the metal layer includes one selected from a group consisting of Au, Ag, Cu, Ni, Au alloy, Ag alloy, Cu alloy and Ni alloy.

Preferably, the substrate has an inclined angle.

Preferably, the thermal bonding layer is one of a Sn layer and a Sn alloy layer.

Preferably, the first structure layer has a shape including one selected from a group consisting of a planar, a zigzag and a spiral shapes.

Preferably, the first structure layer includes a ferromagnetic material.

Preferably, the first structure layer is one of a Ni layer and a Ni alloy layer.

Preferably, the first structure layer further includes a second structure layer including a metal material being one selected from a group consisting of Au, Ag, Cu, Au alloy, Ag alloy and Cu alloy.

Preferably, the substrate is one selected from a group consisting of a Si substrate, a glass substrate, a Ge/Si substrate and a printed circuit board.

Preferably, the fixing elements are hinges including a metal material.

In accordance with another aspect of the present invention, a method for controlling a movable inductor by using magnetism is provided. The method includes steps of (a) providing a substrate; (b) forming a first structure layer on the substrate, wherein the first structure layer has two protruding portions respectively disposed at two sides thereof; (c) forming at least two fixing elements on the substrate, wherein the fixing elements are connected with the protruding portions; (d) forming a thermal bonding layer, which is at least disposed on the fixing elements; and (e) providing an alternating magnetic field to elevate the first structure layer via the protruding portions and the fixing elements by using a repulsion between like poles.

Preferably, the method further includes steps of (d1) placing the substrate on a metal layer; (e1) heating and melting the thermal bonding layer via the metal layer by using an electromagnetic induction; and (f) removing the alternating magnetic field for cooling the thermal bonding layer to fix a position of the first structure layer when the first structure layer is elevated to a specific angle.

Preferably, the method further includes steps of (d2) inclining the substrate; and (e2) performing at least one of changing a magnitude of the alternating magnetic field and adjusting a position of the alternating magnetic field.

Preferably, the metal layer includes one selected from a group consisting of Au, Ag, Cu, Ni, Au alloy, Ag alloy, Cu alloy and Ni alloy.

Preferably, the method further includes steps of (b1) forming a metal layer on the substrate, wherein the metal layer is coplanar with the fixing elements, and a part of the thermal bonding layer is disposed on the metal layer; (e1) heating and melting the thermal bonding layer via the metal layer by using an electromagnetic induction; and (f) removing the alternating magnetic field for cooling the thermal bonding layer to fix a position of the first structure layer when the first structure layer is elevated to a specific angle.

Preferably, the method further includes steps of (d2) inclining the substrate; and (e2) performing at least one of changing a magnitude of the alternating magnetic field and adjusting a position of the alternating magnetic field.

Preferably, the metal layer includes one selected from a group consisting of Au, Ag, Cu, Ni, Au alloy, Ag alloy, Cu alloy and Ni alloy.

Preferably, the thermal bonding layer is one of a Sn layer and a Sn alloy layer.

Preferably, the first structure layer includes a ferromagnetic material, is one of a Ni layer and a Ni alloy layer, and has a shape including one selected from a group consisting of a planar, a zigzag and a spiral shapes.

Preferably, the first structure layer further includes a second structure layer including a metal material being one selected from a group consisting of Au, Ag, Cu, Au alloy, Ag alloy and Cu alloy.

Preferably, the substrate is one selected from a group consisting of a Si substrate, a glass substrate, a Ge/Si substrate and a printed circuit board.

Preferably, the fixing elements are hinges including a metal material.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows the structure of a movable inductor according to a first embodiment of the present invention;

FIG. 2(a) shows the operation of the movable inductor according to the first embodiment of the present invention;

FIG. 2(b) is a lateral view of the movable inductor according to the first embodiment of the present invention;

FIG. 3 is a lateral view of the movable inductor according to a second embodiment of the present invention;

FIG. 4 shows the structure of a movable inductor according to a third embodiment of the present invention;

FIG. 5(a) shows the operation of the movable inductor according to the third embodiment of the present invention;

FIG. 5(b) is a lateral view of the movable inductor according to the third embodiment of the present invention; and

FIG. 6 shows the relationship between the Q value and the frequency for different structures.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

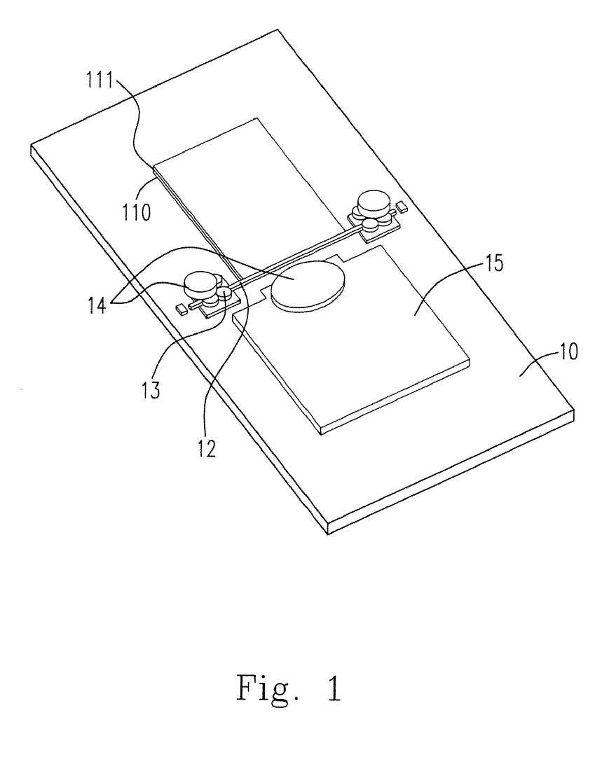

Please refer to FIG. 1, which shows the structure of a movable inductor according to a first embodiment of the present invention. The movable inductor includes a Si substrate 10, and a first structure layer 110 is disposed on the Si substrate 10. Two protruding portions 12 are disposed at two sides of the first structure layer 110 respectively for connecting with two fixing elements 13. A metal layer 15 is disposed on the Si substrate 10. A thermal bonding layer 14 is disposed on the metal layer 15 and the fixing elements 13. The first structure layer 110 further includes a second structure layer 111.

In this embodiment, the above-mentioned layers are formed on the Si substrate 10 by electroplating. However, this is only a preferred implementing way. The above-mentioned layers can also be formed on the Si substrate 10 by physical vapor deposition (PVD). Firstly, the first structure layer 110, the second structure layer 111, the protruding portions 12 and the metal layer 15 are sequentially formed on the Si substrate 10. Then, the fixing elements 13 are formed on the Si substrate 10. Finally, the thermal bonding layer 14 is formed on the metal layer 15 and the fixing elements 13. The manufacturing processes used in this embodiment are all prior arts, which will not be described here. In the above-mentioned steps, the first structure layer 110 and the second structure layer 11 are both lying on the Si substrate 10. The Si substrate 10 can be a Si substrate, a glass substrate, a Ge/Si substrate or a printed circuit board. The first structure layer 111 is made of a ferromagnetic material, e.g. Ni or Ni alloy. The fixing elements 13, the metal layer 15 and the second structure layer 111 are all made of a metal material, e.g. Au, Ag, Cu, Au alloy, Ag alloy or Cu alloy. The thermal bonding layer 14 is made of Sn or Sn alloy, for serving as a welding material to fix the first and the second structure layers 110, 111 after their positions are changed.

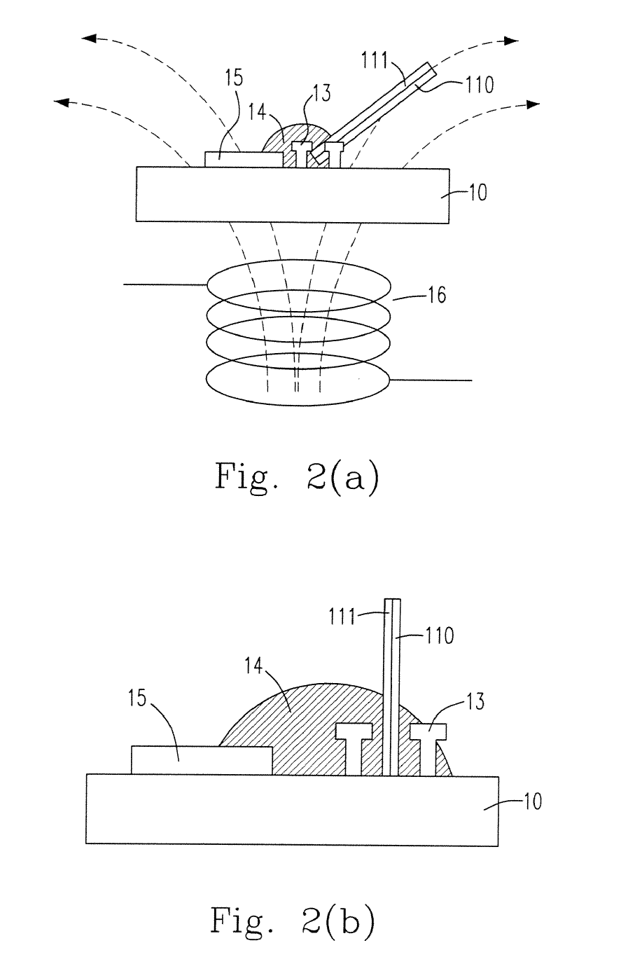

Please refer to FIG. 2(a), which shows the operation of the movable inductor according to the first embodiment of the present invention. Subsequently, the movable inductor is placed on a coil (not shown) which provides an alternating magnetic field 16. Since the first structure layer 110 is made of a ferromagnetic material, it will be turned into a magnet whose direction is identical to that of the alternating magnetic field 16. At this time, the first structure layer 110 is elevated via the protruding portions 12, which are connected with the fixing elements for serving as axles, until it is parallel to the magnetic line of force. In this situation, the elevating angle can be freely controlled by changing the magnitude of the alternating magnetic field 16 or adjusting the position of the alternating magnetic field 16. Moreover, the fixing elements 13, i.e. the so-called hinges, further have a function of positioning other than serving as pivots when the first structure layer 110 is elevated. This prevents the first structure layer 110 from being separated from the Si substrate 10 or deviated from the original position when moving.

When the movable inductor is within the alternating magnetic field 16, due to the electromagnetic induction principle, the metal layer 15 which has the maximum cutting area with the alternating magnetic field 16 will achieve a temperature sufficient to melt the thermal bonding layer 14. Please refer to FIG. 2(b), which is a lateral view of the movable inductor according to the first embodiment of the present invention. As shown in FIG. 2(b), the coil is removed to eliminate the alternating magnetic field 16 so that the thermal bonding layer 14 will be turned into a solid to fix the first structure layer 110 at a specific elevating angle.

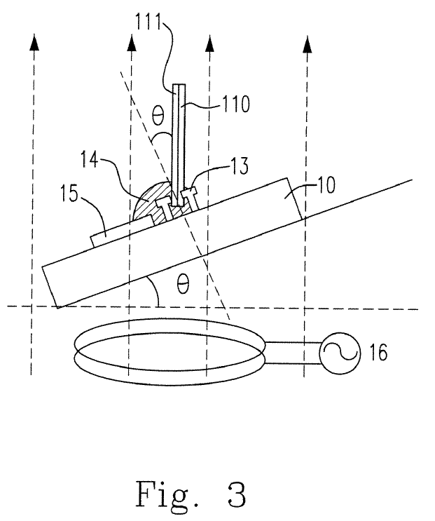

Please refer to FIG. 3, which is a lateral view of the movable inductor according to a second embodiment of the present invention. When the angle is to be controlled, the Si substrate 10 can be directly elevated to an expected inclined angle or placed on an inclined platform. In this way, it is unnecessary to further control the magnitude of the alternating magnetic field 16. The included angle between the first structure layer 110 and the vertical plane will be equal to that between the Si substrate 10 and the horizontal plane. Then, the alternating magnetic field 16 is eliminated so that the thermal bonding layer 14 will be cooled to fix the first structure layer 110, thereby completing the movable inductor at a specific angle.

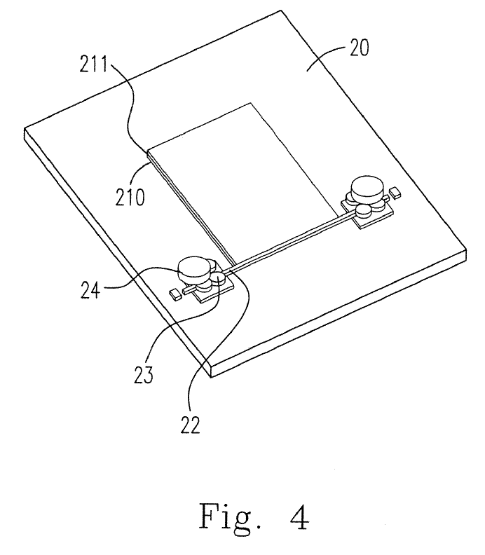

Please refer to FIG. 4, which shows the structure of a movable inductor according to a third embodiment of the present invention. The movable inductor includes a Si substrate 20, and a first structure layer 210 is disposed on the Si substrate 20. Two protruding portions 22 are disposed at two sides of the first structure layer 210 respectively for connecting with two fixing elements 23. A thermal bonding layer 24 is disposed on the fixing elements 23. The first structure layer 210 further includes a second structure layer 211.

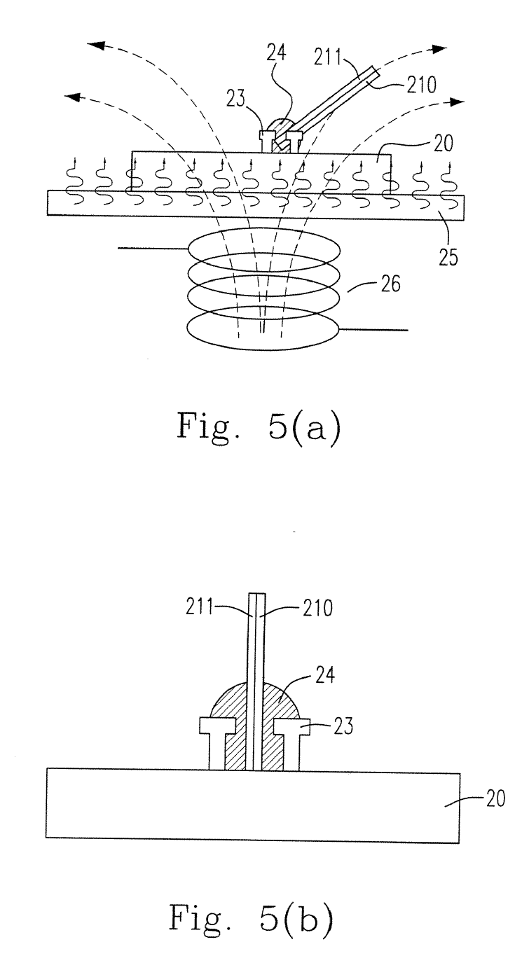

Similarly, the first structure layer 210 is lying on the substrate 20 at present. Please refer to FIGS. 5(a) and 5(b). FIG. 5(a) shows the operation of the movable inductor according to the third embodiment of the present invention, and FIG. 5(b) is a lateral view of the movable inductor according to the third embodiment of the present invention. The above-mentioned layers are placed on a metal layer 25, which is made of Ni, Cu, Ni alloy or Cu alloy. Next, an alternating magnetic field 26 is provided to heat up the metal layer 25 by using the electromagnetic induction principle, thereby heating up the layers on the metal layer 25. At this time, the thermal bonding layer 24 will be melted. When the first structure layer 211 is elevated to a desirable angle, the alternating magnetic field 26 is eliminated to solidify the thermal bonding layer 24, thereby completing the movable inductor of the present invention. Compared with the first embodiment, the metal layer 25 is not included in the entire movable inductor. Hence, the size of the movable inductor can be reduced and the application range thereof can be increased.

The method of the second embodiment can also be used in this embodiment by elevating the metal layer 25 to an expected inclined angle or placing it on an inclined platform and then providing the alternating magnetic field 26, thereby completing the movable inductor at a specific angle.

Through the method of the present invention, the movable inductor has the effect of self-assembling. Besides, if the included angle between the first structure layer and the Si substrate is changed, the Q value of the inductor and the corresponding fᵣₑₛ will be changed accordingly so that these two values can be arbitrarily adjusted. Hence, the angle can be changed according to actual needs. The following table shows the corresponding Q values and fᵣₑₛ for three different angles.

| | 0° | 45° | 90° |
|---|---|---|---|
| Q | 0.537 | 0.919 | 1.114 |
| fᵣₑₛ(GHz) | 5.764 | 6.842 | 6.483 |

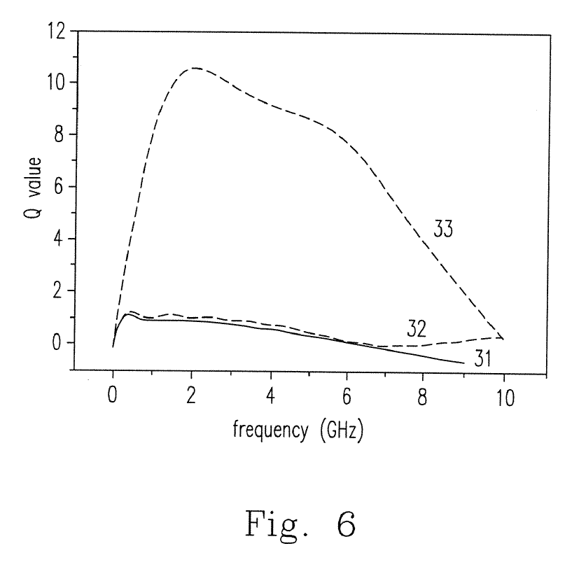

Please refer to FIG. 6, which shows the relationship between the Q value and the frequency for different structures. The curve 31 is obtained by measuring the Q value of the inductor with the first structure layer 110 of 10 um Ni. The curve 32 is obtained by simulating the Q value of the inductor with the first structure layer 110 of 10 um Ni. The curve 33 is obtained by simulating the Q value of the inductor with the first structure layer 110 of 1 um Ni and the second structure layer 111 of 9 um Cu. As shown in FIG. 6, the curve 33 can reach the Q value of 10.6 at most. Therefore, the inductor with the second structure layer 111 of Cu has the best efficiency.

The shapes of the first and the second structure layers 110, 111 can be planar, zigzag or spiral. The forms of the first and the second structure layers 110, 111 are not limited, which can be square, rectangular or round, etc. Furthermore, the number of zigzagging and whether the structures of the first and the second structure layers 110, 111 are single planes are not limited, which can be determined according to actual needs.

Based on the above, the present invention provides a method for controlling the movable inductor by using magnetism and the device thereof to freely control the elevating angle of the inductor and make it have the effect of self-assembling. Besides, the Q value of the inductor and the corresponding fᵣₑₛ can be adjusted.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A movable inductor using a magnetism, comprising:
a substrate;
a first structure layer disposed on the substrate, and having two protruding portions respectively disposed at two sides thereof;
at least two fixing elements disposed on the substrate, and connected with the protruding portions; and
a thermal bonding layer at least disposed on the fixing elements.

2. A movable inductor as claimed in claim 1, further comprising a metal layer disposed on the substrate and coplanar with the fixing elements, wherein a part of the thermal bonding layer is disposed on the metal layer.

3. A movable inductor as claimed in claim 2, wherein the metal layer comprises one selected from a group consisting of Au, Ag, Cu, Ni, Au alloy, Ag alloy, Cu alloy and Ni alloy.

4. A movable inductor as claimed in claim 1, further comprising a metal layer disposed beneath the substrate.

5. A movable inductor as claimed in claim 4, wherein the metal layer comprises one selected from a group consisting of Au, Ag, Cu, Ni, Au alloy, Ag alloy, Cu alloy and Ni alloy.

6. A movable inductor as claimed in claim 1, wherein the substrate has an inclined angle.

7. A movable inductor as claimed in claim 1, wherein the thermal bonding layer is one of a Sn layer and a Sn alloy layer.

8. A movable inductor as claimed in claim 1, wherein the first structure layer has a shape including one selected from a group consisting of a planar, a zigzag and a spiral shapes.

9. A movable inductor as claimed in claim 1, wherein the first structure layer comprises a ferromagnetic material.

10. A movable inductor as claimed in claim 9, wherein the first structure layer is one of a Ni layer and a Ni alloy layer.

11. A movable inductor as claimed in claim 9, wherein the first structure layer further comprises a second structure layer including a metal material being one selected from a group consisting of Au, Ag, Cu, Au alloy, Ag alloy and Cu alloy.

12. A movable inductor as claimed in claim 1, wherein the substrate is one selected from a group consisting of a Si substrate, a glass substrate, a Ge/Si substrate and a printed circuit board.

13. A movable inductor as claimed in claim 1, wherein the fixing elements are hinges including a metal material.

14. A method for controlling a movable inductor by using a magnetism, comprising steps of:
(a) providing a substrate;
(b) forming a first structure layer on the substrate, wherein the first structure layer has two protruding portions respectively disposed at two sides thereof;
(c) forming at least two fixing elements on the substrate, wherein the fixing elements are connected with the protruding portions;
(d) forming a thermal bonding layer, which is at least disposed on the fixing elements; and
(e) providing an alternating magnetic field to elevate the first structure layer via the protruding portions and the fixing elements by using a repulsion between like poles.

15. A method as claimed in claim 14, further comprising steps of:
(d1) placing the substrate on a metal layer;
(e1) heating and melting the thermal bonding layer via the metal layer by using an electromagnetic induction; and
(f) removing the alternating magnetic field for cooling the thermal bonding layer to fix a position of the first structure layer when the first structure layer is elevated to a specific angle.

16. A method as claimed in claim 15, further comprising steps of:
(d2) inclining the substrate; and
(e2) performing at least one of changing a magnitude of the alternating magnetic field and adjusting a position of the alternating magnetic field.

17. A method as claimed in claim 15, wherein the metal layer comprises one selected from a group consisting of Au, Ag, Cu, Ni, Au alloy, Ag alloy, Cu alloy and Ni alloy.

18. A method as claimed in claim 14, further comprising steps of:
(b1) forming a metal layer on the substrate, wherein the metal layer is coplanar with the fixing elements, and a part of the thermal bonding layer is disposed on the metal layer;
(e1) heating and melting the thermal bonding layer via the metal layer by using an electromagnetic induction; and
(f) removing the alternating magnetic field for cooling the thermal bonding layer to fix a position of the first structure layer when the first structure layer is elevated to a specific angle.

19. A method as claimed in claim 18, further comprising steps of:
(d2) inclining the substrate; and
(e2) performing at least one of changing a magnitude of the alternating magnetic field and adjusting a position of the alternating magnetic field.

20. A method as claimed in claim 18, wherein the metal layer comprises one selected from a group consisting of Au, Ag, Cu, Ni, Au alloy, Ag alloy, Cu alloy and Ni alloy.

21. A method as claimed in claim 14, wherein the thermal bonding layer is one of a Sn layer and a Sn alloy layer.

22. A method as claimed in claim 14, wherein the first structure layer comprises a ferromagnetic material, is one of a Ni layer and a Ni alloy layer, and has a shape including one selected from a group consisting of a planar, a zigzag and a spiral shapes.

23. A method as claimed in claim 22, wherein the first structure layer further comprises a second structure layer including a metal material being one selected from a group consisting of Au, Ag, Cu, Au alloy, Ag alloy and Cu alloy.

24. A method as claimed in claim 14, wherein the substrate is one selected from a group consisting of a Si substrate, a glass substrate, a Ge/Si substrate and a printed circuit board.

25. A method as claimed in claim 14, wherein the fixing elements are hinges including a metal material.
